(19) United States
(12) Patent Application Publication
(10) Pub. No.: US 2018/0247298 A1
(43) Pub. Date: Aug. 30, 2018

(54) METHODS AND SYSTEMS FOR COMMUNICATING SCANNED ITEM INFORMATION BETWEEN MERCHANT EQUIPMENT FOR SCANNING OR SELECTING AN ITEM AND A MOBILE DEVICE

(71) Applicant: Omnyway, Inc., Redwood City, CA (US)

(72) Inventors: Mohammad Khan, San Jose, CA (US); Ashok Narasimhan, San Francisco, CA (US); William N. Melton, San Francisco, CA (US)

(21) Appl. No.: 15/758,688

(22) PCT Filed: Sep. 12, 2016
(86) PCT No.: PCT/US2016/051386

§ 371 Date: Mar. 8, 2018

Related U.S. Application Data
(60) Provisional application No. 62/216,367, filed on Sep. 10, 2015.

(51) Int. Cl. G06Q 20/32; G06Q 20/20; G06Q 20/38

(52) U.S. Cl. CPC G06Q 20/3276; G06Q 20/206; G06Q 20/387; G06Q 20/3278; G06Q 20/201; G06Q 20/208; G06Q 20/202

(57) ABSTRACT

Methods and systems for communicating item information between merchant equipment for scanning or selecting the item and a customer's mobile device are provided. According to one aspect, a method for communicating item information between merchant equipment for scanning or selecting the item and a customer's mobile device includes, at a mobile device of a customer: receiving information for identifying merchant equipment for scanning or selecting an item; using the received information to establish a digital communication connection between the mobile device and the identified merchant equipment; and receiving information related to an item being scanned by the merchant equipment via the digital communication connection.

### RELATED APPLICATIONS

This application claims the benefit of provisional application Ser. No. 62/216,367, filed Sep. 10, 2015, the disclosure of which is hereby incorporated herein by reference in its entirety. This application is related to international application serial number PCT/US16/50800, filed Sep. 8, 2016, the disclosure of which is hereby incorporated herein by reference in its entirety.

### TECHNICAL FIELD

This disclosure relates to allowing a customer's mobile device to interact with merchant equipment, such as a Point Of Sale (POS) terminal, price scanner, etc., such that the mobile device receives information about the item being scanned or selected while it is being scanned or selected, or shortly thereafter. More specifically, it relates to methods and systems for communicating item information between a POS terminal or other merchant equipment and a mobile device.

### BACKGROUND

Conventional merchant equipment, such as POS terminals, price check scanners, and the like, do not transmit or otherwise share with non-merchant devices information about a particular item being scanned or selected, while or around the time that the item is being scanned or selected.

### SUMMARY

The subject matter disclosed herein includes methods and systems for communicating item information between merchant equipment for scanning or selecting the item and a customer's mobile device.

According to one aspect, the subject matter described herein includes a method for communicating item information between merchant equipment for scanning or selecting the item and a customer's mobile device. The method includes, at a mobile device of a customer: receiving information for identifying merchant equipment for scanning or selecting an item; using the received information to establish a digital communication connection between the mobile device and the identified merchant equipment; and receiving information related to an item being scanned or selected by the merchant equipment via the digital communication connection.

In one embodiment, the merchant equipment is at least one of: a point of sale terminal; a price checking kiosk; and a display showing discounts, specials, or coupons.

In one embodiment, receiving the first information includes at least one of: scanning and decoding a quick response (QR) code or bar code that encodes the information; receiving the information using a near field communication (NFC) protocol; and receiving or recording and then decoding an audio sample that encodes the information.

In one embodiment, the first information includes at least one of: a network address of the equipment; a identifier (ID) of the equipment; a name of the equipment; and a location or physical address of the equipment.

In one embodiment, using the first information to establish a digital communication connection between the mobile device and the identified merchant equipment includes at least one of: establishing a wireless, optical, audio, or NFC connection between the mobile device and the equipment; establishing a connection between the mobile device and the equipment using an Internet or telecommunication networking protocol; and establishing a connection between the mobile device and the equipment using an infrared (IR) or visible light communication protocol.

In one embodiment, the method further comprises displaying the second information to the customer via the mobile device.

In one embodiment, the method further comprises using the second information to identify an item and displaying the identified item or class of item to the customer via the mobile device.

In one embodiment, the method further comprises using the second information to determine whether a coupon associated with the item or class of item is available for use by the customer.

In one embodiment, the method further comprises determining that a coupon associated with the item or class of item is available and at least one of: automatically applying the identified coupon to the item; determining that the customer does not have or have access to the coupon and, in response to that determination, offering to provide the coupon to the customer; providing the coupon to the customer for storage, immediate use, and/or later use; and prompting the customer to indicate whether or not to apply the identified coupon to the item.

In one embodiment, the applied coupons are automatically redeemed by or on behalf of the merchant.

In one embodiment, the identified coupon is stored on the mobile device.

In one embodiment, the identified coupon is stored on a backend server and associated with the mobile device and/or the customer.

In one embodiment, the method further comprises displaying a running and/or final total amount of the scanned or selected items to the customer via the mobile device.

In one embodiment, the method further comprises initiating purchase of the scanned or selected items using at least one of: a payment application on the mobile device; a credit, debit, or payment card; and cash.

In one embodiment, the method further comprises adding the scanned or selected items to an online cart or wishlist.

According to another aspect, the subject matter described herein includes a system for communicating item information between merchant equipment for scanning or selecting the item and a customer's mobile device. The system includes a mobile device of a customer, where the device is configured to receive first information for identifying a merchant equipment for scanning or selecting an item, use the first information to establish a digital communication connection between the mobile device and the identified merchant equipment, and receive second information for identifying an item or class of item being scanned or selected by the merchant equipment via the digital communication connection.

In one embodiment, the system includes a merchant equipment.

In one embodiment, the merchant equipment is at least one of: a point of sale terminal; a price checking kiosk; and a display showing discounts, specials, or coupons.

In one embodiment, the mobile device is configured to receive the first information by at least one of: scanning and decoding a QR code or bar code that encodes the information; receiving the information using a NFC protocol; and receiving or recording and then decoding an audio sample that encodes the information.

In one embodiment, the first information includes at least one of: a network address of the equipment; a ID of the equipment; a name of the equipment; and a location or physical address of the equipment.

In one embodiment, the mobile device is configured to use the first information to establish a digital communication connection between the mobile device and the identified merchant equipment by at least one of: establishing a wireless, optical, audio, or NFC connection between the mobile device and the equipment; establishing a connection between the mobile device and the equipment using an Internet or telecommunication networking protocol; and establishing a connection between the mobile device and the equipment using an IR or visible light communication protocol.

In one embodiment, the mobile device is configured to display the second information to the customer via the mobile device.

In one embodiment, the second information is used to identify an item and the identified item or class of item is displayed to the customer via the mobile device.

In one embodiment, the second information is used to determine whether a coupon associated with the item or class of item is available for use by the customer.

In one embodiment, upon determining that a coupon associated with the item or class of item is available, the mobile device is configured to at least one of: automatically apply the identified coupon to the item; determine that the customer does not have or have access to the coupon and, in response to that determination, offer to provide the coupon to the customer; provide the coupon to the customer for storage, immediate use, and/or later use; and prompt the customer to indicate whether or not to apply the identified coupon to the item.

In one embodiment, the applied coupons are automatically redeemed by or on behalf of the merchant.

In one embodiment, the identified coupon is stored on the mobile device.

In one embodiment, the identified coupon is stored on a backend server and associated with the mobile device and/or the customer.

In one embodiment, the mobile device displays a running and/or final total amount of the scanned or selected items to the customer.

In one embodiment, the mobile device adds the scanned or selected items to an online cart or wishlist.

According to yet another embodiment, a system for communicating item information between a merchant equipment for scanning or selecting the item and a customer's mobile device comprises a mobile backend server. The mobile backend server comprises a network interface, one or more processors, and memory storing instructions executable by the one or more processors. The mobile backend server is operable to: receive, from a mobile device, first information for identifying a merchant equipment for scanning or selecting an item; use the first information to establish a digital communication connection between the mobile device and a merchant backend server associated with the merchant equipment; receive, from the merchant backend server via the digital communication connection, second information for identifying an item or class of item being scanned or selected by the merchant equipment; and send the second information to the mobile device.

In one embodiment, the first information includes at least one of: a network address of the equipment; a ID of the equipment; a name of the equipment; and a location or physical address of the equipment.

In one embodiment, the first information includes information identifying a user of the mobile device, and wherein the mobile backend server is further operable to identify the user of the mobile device.

In one embodiment, the mobile backend server is further operable to determine whether there are any incentives available to the user.

In one embodiment, upon determination that incentives are available to the user, the mobile backend server is further operable to at least one of: automatically apply the incentive; notify the user of the incentive; and query the user to determine whether the user wants to apply the incentive or not.

In one embodiment, the mobile backend server is further operable to provide the identity of the user to the merchant backend server.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for communicating item information between merchant equipment for scanning or selecting the item and a customer's mobile device according to an embodiment of the subject matter described herein.

FIG. 2 is a flow chart illustrating an exemplary process for communicating item information between a merchant equipment for scanning or selecting the item and a customer's mobile device according to an embodiment of the subject matter described herein.

FIG. 3 is a block diagram illustrating an exemplary system for communicating item information between merchant equipment for scanning or selecting the item and a customer's mobile device according to another embodiment of the subject matter described herein.

FIG. 4 is a block diagram illustrating an exemplary system for communicating item information between merchant equipment for scanning or selecting the item and a customer's mobile device according to yet another embodiment of the subject matter described herein.

### DETAILED DESCRIPTION

Methods and systems for communicating item information between merchant equipment for scanning or selecting the item and a customer's mobile device are provided herein.

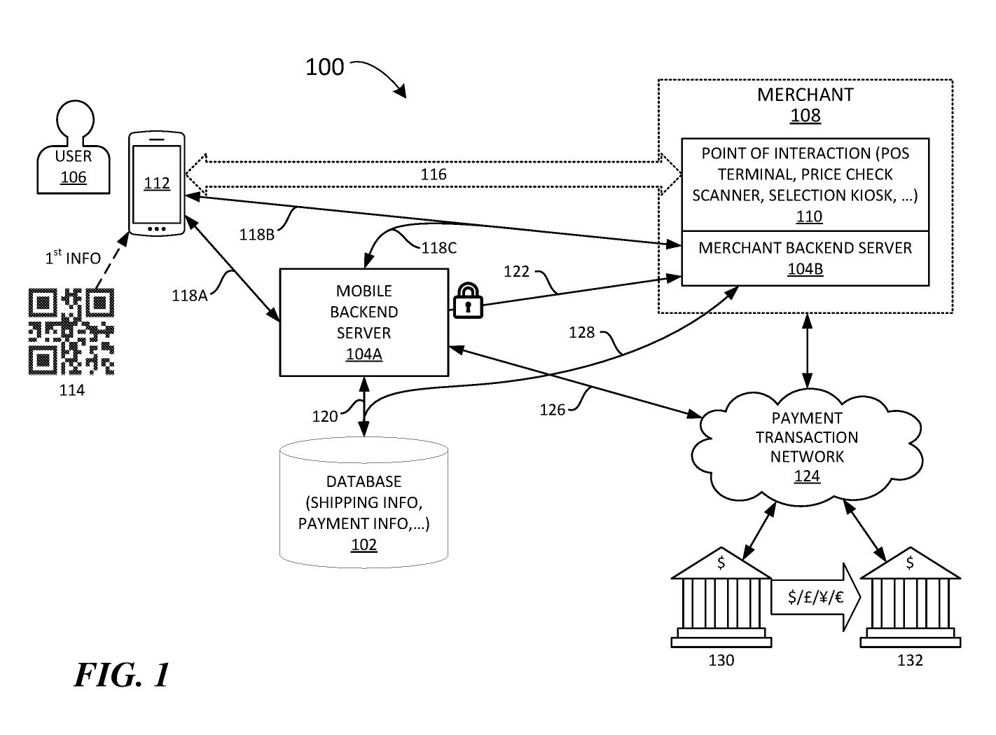

FIG. 1 is a block diagram illustrating an exemplary system for communicating item information between merchant equipment for scanning or selecting the item and a customer's mobile device according to an embodiment of the subject matter described herein.

In the embodiment illustrated in FIG. 1, system 100 includes a database 102 for storing and maintaining user information, a mobile backend server 104A, and a merchant backend server 104B. FIG. 1 illustrates a scenario in which a customer 106 (also referred to herein as “user 106”) is at a merchant location 108. Customer 106 is engaged with or interacting with merchant equipment 110 (which may also be referred to point of interaction 110), which may be a POS terminal, a price check kiosk, or other equipment with which user 106 may use his or her mobile device 112 to engage in an interaction.

In one embodiment, mobile device 112 receives first information for identifying the merchant equipment 110. In one embodiment, this first information may be received by the mobile device 112 when it scans a QR code 114 that includes the first information. In one embodiment, the QR code 114 may be provided by the merchant 108, e.g., by a POS terminal, price checker, or any type of information display unit, displayed on a sign or sticker, and so on, which the mobile device scans, takes a picture of, or otherwise captures and decodes. The mobile device 112 uses the first information to establish a digital communication connection 116 between the mobile device 112 and the identified merchant equipment 110. Alternatively, mobile device 112 may receive the first information by scanning a bar code, receiving an image, or receiving a sound file or audio sample that includes, the first information encoded within it.

It is noted that the first information contained with the QR code or other communication vehicle does not include transaction information, but rather contains information needed to establish the connection 116. Such information may include, for example, information that identifies the point of interaction 110 (such as a POS identifier (POSID)), information that identifies the merchant 108 (such as a Merchant identifier (MID)), information that identifies the store (such as a store identifier (STOREID)) or physical location (such as a geographic location), other non-transaction information, or combinations of the above.

In one embodiment, the mobile device 112 establishes a connection 116 directly with the point of interaction 110. Alternatively, the mobile device 112 may establish a connection to the point of interaction 110 through the mobile backend server 104A and/or the merchant backend server 104B (communication paths 118A, 118B, and 118C).

In one embodiment, backend server 104A is configured to authenticate the user before completing the transaction. This authentication may be done with the help of mobile device 112 and/or point of interaction 110, e.g., by requiring the entry of a password, passcode, or passphrase, by fingerprint sensor or other biometric information, etc.

In one embodiment, database 102 may store customer-specific information, including, but not limited to, information that may pertain to an electronic transaction, such as loyalty card information, preferred payment information, discount information, etc. In one embodiment, mobile backend server 104A receives user information that identifies either user 106 directly (e.g., the user's name or other identifying information) or indirectly (e.g., by identifying mobile device 112 and using that information to identify the user of that mobile device.) Mobile backend server 104A may use this information to determine transaction information to be used to initiate an electronic transaction, e.g., by querying database 102 (communication 120). In one embodiment, mobile backend server 104A may send the transaction information to point of interaction 110 (communication 122), which initiates the transaction with a payment transaction network 124, for example, or mobile backend server 104A may send the transaction information directly to payment transaction network 124 (communication path 126). In one embodiment, the merchant backend server 104B may be able to access the database 120 directly (communication path 128).

The electronic transaction may be a payment or non-payment transaction. Examples of electronic transactions include, but are not limited to, a payment or purchase, a credit transaction, a debit transaction, a prepaid transaction, a deposit, a withdrawal, a money transfer, a transaction involving a loyalty program, a transaction involving a rewards program, and a transaction involving a diet, health, or fitness program. An electronic transaction may involve the transfer of funds or other assets from one person, business entity, bank, or financial institution 130 to another person, business entity, bank, or financial institution 132.

In one embodiment, user information may be stored in database 102 as part of a registration process. For example, the user of mobile device 112 may use an application within mobile device 112 to connect with mobile backend server 104A for the purpose of collecting the information that will be stored within database 102. In one embodiment, user 106 uses the application to enter credit card information, e.g., by manual entry, by taking an image of the card, by swiping the card using a magstripe reader attached to mobile device 112, or other means. The application communicates that information to mobile backend server. Alternatively, the user may use a secure web portal to enter that information using mobile device 112, a personal computer, etc. In one embodiment, the user may be asked to enter additional information to authorize the card data. Examples of authentication information include, but are not limited to, the CVV or CVC number commonly printed on the back of many credit or debit cards, user ID, password, passcode, or personal information number (PIN), fingerprint or other biometric information, and so on. This additional authentication information may or may not be stored within database 102, according to the rules and regulations as well as need for a particular kind of information.

In one embodiment, mobile backend server 104A may provide this authentication information along with transaction information 122. Other methods of populating database 102 are also within the subject matter described herein. The authentication information may be data that is used to perform the authentication (e.g., by mobile backend server 104A or another entity), an indication that the user was successfully authenticated, or both. In one embodiment, the fact that the authentication came from mobile device 112 (or from mobile backend server 104A, later) may be considered sufficient proof of authenticity.

For the sake of illustration of the concepts described herein, the example illustrated in FIG. 1 is an electronic payment transaction, but other electronic transactions, including both payment transactions and non-payment transactions, are also within the scope of the subject matter described herein. Examples of electronic transactions include, but are not limited to: a payment or purchase; a credit transaction; a debit transaction; a prepaid transaction; a deposit; a withdrawal; a money transfer; a transaction involving a loyalty program; a transaction involving a rewards program; and a transaction involving a diet, health, or fitness program. In one embodiment, the electronic transaction may be a payment transaction that is processed as a “card present” transaction. Likewise, the electronic transaction may be payment transaction that is processed as a “card not present” transaction. The methods and systems described herein may be applied to any electronic transaction where it is desirable to avoid transmission of sensitive data over a network as well as other forms of potential exposure to unauthorized entities.

The mobile device 112 may then begin receiving second (and additional) information for identifying an item or class of item being scanned or selected by the merchant equipment via the digital communication connection. In this manner, the user 106 can use the mobile device 112 to see the items as they are scanned or selected.

Scanned. An item may be scanned—e.g., reading the barcode on the product or the product packaging—by a cashier or other employee of the merchant, such as during a checkout process. Alternatively, the item may be scanned by the user 106 during a self-checkout process, or as part of a price check function.

Selected. Sometimes items to be purchased are not scanned but are instead selected from a menu of options, as is the case with most restaurants—e.g., the cashier takes the customer's order and uses the POS touch screen or other input method to identify ordered or purchased items, rather than scanning the item itself.

However the item is identified, either by scanning or by selection, the point of interaction 110 communicates information about that item to the mobile device 112. This makes possible a wide range of enhanced functions.

During checkout, for example, the customer 106 is able to connect his or her mobile device 112 to a specific POS terminal, price check kiosk, or other merchant equipment 110 via a digital communication connection 116. As items are being scanned, item information is passed to the user's mobile device via the digital connection 116. The item information may be a Stock Keeping Unit (SKU) number, product type code, or other data that identifies the item or the class of item being scanned.

Mobile device 112 may display the list of scanned or selected items to the customer. In one embodiment, the mobile device 112 may parse the list of items or item information to determine whether or not there are any coupons that might apply. The coupons may be stored on the mobile device 112, in a repository of customer data on a backend server 104A and/or 104B, or other location. If coupons are found, they may be automatically applied, or the customer may be prompted to indicate whether or not to apply the pertinent coupon. Coupons that are applied to the purchase by customer 106 may then be automatically processed by or on behalf of the merchant, thus avoiding the tedious, manual methods used by conventional systems.

The items being scanned may be being scanned for purchase (e.g., at a POS terminal), scanned for later purchase (e.g., to be added to a wish list), or scanned for the purpose of determining price or other information about the item (e.g., at a price check kiosk), with or without the intent to subsequently purchase the item. Mobile device 112 may also display the total to the customer. Where purchase is desired, the purchase may be effected by a payment application on the mobile device, by the customer paying cash or using a credit or debit card, by other payment instrument, and/or a combination of the above.

The information communicated between merchant equipment 110 and mobile device 112 may be treated as “big data,” e.g., stored and analyzed to determine trends and triggers, etc.

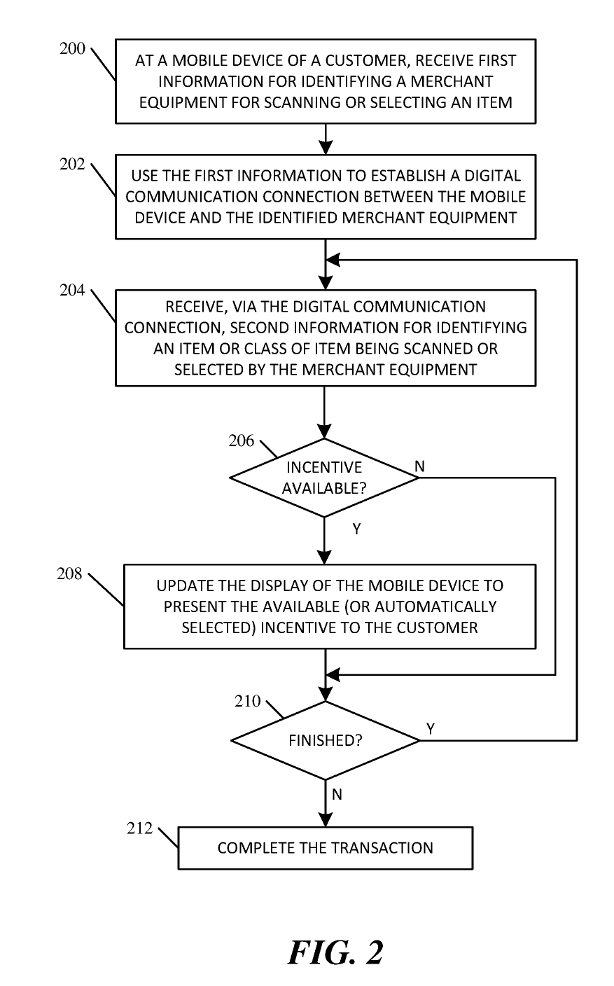

FIG. 2 is a flow chart illustrating an exemplary process for communicating item information between a merchant equipment for scanning or selecting the item and a customer's mobile device according to an embodiment of the subject matter described herein. In the embodiment illustrated in FIG. 2, the process includes the following steps:

At step 200, a mobile device of a customer 112 receives first information for identifying a merchant equipment 110 for scanning or selecting an item. In one embodiment, this first information may be received by the mobile device 112 when it scans a QR 114 code that includes the first information. In one embodiment, the QR code 114 may be provided by the merchant, e.g., by a POS terminal, price checker, or any type of information display unit, displayed on a sign or sticker, and so on, which the mobile device 112 scans, takes a picture of, or otherwise captures and decodes. In one embodiment, the merchant equipment 110 gets the QR code from the merchant backend server 104B. In one embodiment, the merchant backend server 104B gets the QR code (or the information encoded by the QR code) from the mobile backend server 104A. In one embodiment, the QR code can contain additional information, such as a security checksum, that is used to authenticate the information encoded within the QR code, to verify that the address within the QR code is authentic, i.e., that the user 106 is not being directed to a malicious server.

At step 202, the first information is used to establish a digital communication connection 116 between the mobile device and the identified merchant equipment. In one embodiment, the mobile device provides that information, along with information that can identify the user directly (e.g., a user identity (USERID) or indirectly (e.g., information that identifies the mobile device 112, from which the user identity can be determined) to mobile backend server 104A, which forwards that information to the merchant backend server 104B.

Thus, digital communication connection 116 between the point of interaction 110 and the mobile device 112 is via the merchant backend server 104B and the mobile backend server 104A.

At step 204, the mobile device receives, via the digital communication connection 116, second information for identifying an item or class of item being scanned or selected by the merchant equipment. In one embodiment, every piece of merchant equipment 110 is connected to the merchant backend server 104B. This allows the merchant to configure the merchant backend server 104B as a common point of management for all POS terminals, for example.

In one embodiment, a user of the merchant equipment 110 scans a Universal Product Code (UPC) printed on an item or on an item's packaging. This information is sent by the merchant equipment 110 to the merchant backend server 104B. In one embodiment, the merchant equipment 110 may provide additional information about the item, such as weight, quantity, and so on. In one embodiment, the merchant backend server 104B uses the UPC to look up information about the item, such as its SKU number, description, price, and so on. Some or all of this information may be passed to the mobile backend server 104A, which forwards some or all of that information to the mobile device 112. At this time the mobile device 112 may update its display, e.g., to update a running list of items, to recalculate a running total, and so on.

At step 206, it is determined whether one or more incentives (coupon, special offer, etc.) are available for the item or class of item scanned or selected. This determination may be performed, for example, by the merchant backend server 104B, by the mobile backend server 104A, by the mobile device 112, or any combination of the above. For example, the merchant backend server 104B may maintain information about loyalty customers, in which case the merchant backend server 104B may determine that particular incentives are available to the customer 106 as a result of being a loyalty card holder or other. Likewise, the mobile backend server 104A may operate as a repository of incentives for the user 106. Also, the mobile device 112 may store incentives in local memory.

At step 208, the display of the mobile device is updated. This may include, but is not limited to: notifying the user that there is a new incentive available and asking the user whether or not to take advantage of that incentive; notifying the user that an incentive has automatically been used, redeemed, applied, etc.; updating a running total; and updating a list of items scanned or selected. In one embodiment the user may choose how much detail is to be displayed and how much is to be hidden.

If the checkout, scanning, or selection process is complete (step 210), then the process moves to step 212, at which point the transaction is completed. In one embodiment, the merchant backend server 104B may initiate a payment transaction with the payment transaction network 124.

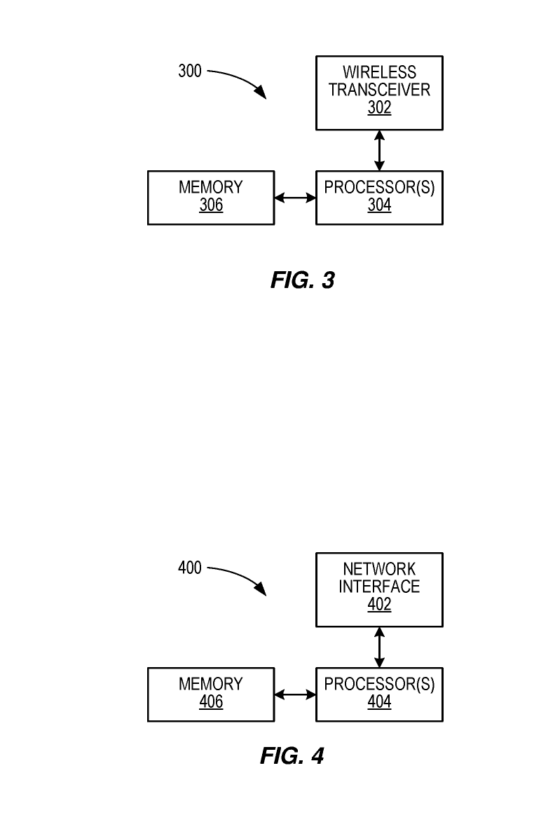

FIG. 3 is a block diagram illustrating an exemplary system for communicating item information between merchant equipment for scanning or selecting the item and a customer's mobile device according to another embodiment of the subject matter described herein. In the embodiment illustrated in FIG. 3, a mobile device of a customer 300 comprises a wireless transceiver 302, one or more processors 304, and memory 306 storing instructions executable by the one more processors 304. Mobile device 300 is operable to receive first information for identifying a merchant equipment for scanning or selecting an item, use the first information to establish a digital communication connection between the mobile device and the identified merchant equipment, and receive second information for identifying an item or class of item being scanned by the merchant equipment via the digital communication connection.

FIG. 4 is a block diagram illustrating an exemplary system for communicating item information between merchant equipment for scanning or selecting the item and a customer's mobile device according to yet another embodiment of the subject matter described herein. In the embodiment illustrated in FIG. 4, a backend server 400 comprises a network interface 402, one or more processors 404, and memory 406 storing instructions executable by the one more processors 404. Backend server 300 is operable to receive, from a mobile device, first information for identifying a merchant equipment for scanning or selecting an item; use the first information to establish a digital communication connection between the mobile device and a merchant backend server associated with the merchant equipment; receive, from the merchant backend server via the digital communication connection, second information for identifying an item or class of item being scanned or selected by the merchant equipment; and send the second information to the mobile device.

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

### Embodiment 1

A method for communicating item information between a merchant equipment for scanning or selecting the item and a customer's mobile device, the method comprising: at a mobile device of a customer: receiving first information for identifying a merchant equipment for scanning or selecting an item; using the first information to establish a digital communication connection between the mobile device and the identified merchant equipment; and receiving second information for identifying an item or class of item being scanned by the merchant equipment via the digital communication connection.

### Embodiment 2

The method of embodiment 1 wherein the merchant equipment is at least one of: a point of sale terminal; a price checking kiosk; and a display showing discounts, specials, or coupons.

### Embodiment 3

The method of embodiment 1 wherein receiving the first information includes at least one of: scanning and decoding a QR code or bar code that encodes the information; receiving the information using a near field communication (NFC) protocol; and receiving or recording and then decoding an audio sample that encodes the information.

### Embodiment 4

The method of embodiment 1 wherein the first information includes at least one of: a network address of the equipment; a identifier (ID) of the equipment; a name of the equipment; and a location or physical address of the equipment.

### Embodiment 5

The method of embodiment 1 wherein using the first information to establish a digital communication connection between the mobile device and the identified merchant equipment includes at least one of: establishing a wireless, optical, audio, or NFC connection between the mobile device and the equipment; establishing a connection between the mobile device and the equipment using an Internet or telecommunication networking protocol; and establishing a connection between the mobile device and the equipment using an infrared (IR) or visible light communication protocol.

### Embodiment 6

The method of embodiment 1 further comprising displaying the second information to the customer via the mobile device.

### Embodiment 7

The method of embodiment 1 further comprising using the second information to identify an item and displaying the identified item or class of item to the customer via the mobile device.

### Embodiment 8

The method of embodiment 1 further comprising using the second information to determine whether a coupon associated with the item or class of item is available for use by the customer.

### Embodiment 9

The method of embodiment 8 comprising determining that a coupon associated with the item or class of item is available and at least one of: automatically applying the identified coupon to the item; determining that the customer does not have or have access to the coupon and, in response to that determination, offering to provide the coupon to the customer; providing the coupon to the customer for storage, immediate use, and/or later use; and prompting the customer to indicate whether or not to apply the identified coupon to the item.

### Embodiment 10

The method of embodiment 9 wherein the applied coupons are automatically redeemed by or on behalf of the merchant.

### Embodiment 11

The method of embodiment 9 wherein the identified coupon was stored on the mobile device.

### Embodiment 12

The method of embodiment 9 wherein the identified coupon was stored on a backend server and associated with the mobile device and/or the customer.

### Embodiment 13

The method of embodiment 1 comprising displaying a running and/or final total amount of the scanned or selected items to the customer via the mobile device.

### Embodiment 14

The method of embodiment 1 comprising initiating purchase of the scanned or selected items using at least one of: a payment application on the mobile device; a credit, debit, or payment card; and cash.

### Embodiment 15

The method of embodiment 1 comprising adding the scanned or selected items to an online cart or wishlist.

### Embodiment 16

A system for communicating item information between a merchant equipment for scanning or selecting the item and a customer's mobile device, the method comprising: a mobile device of a customer, the device configured to: receive first information for identifying a merchant equipment for scanning or selecting an item; use the first information to establish a digital communication connection between the mobile device and the identified merchant equipment; and receive second information for identifying an item or class of item being scanned by the merchant equipment via the digital communication connection.

### Embodiment 17

The system of embodiment 16 including a merchant equipment.

### Embodiment 18

The system of embodiment 17 wherein the merchant equipment is at least one of: a point of sale terminal; a price checking kiosk; and a display showing discounts, specials, or coupons.

### Embodiment 19

The system of embodiment 16 wherein mobile device is configured to receive the first information by at least one of: scanning and decoding a QR code or bar code that encodes the information; receiving the information using a near field communication (NFC) protocol; and receiving or recording and then decoding an audio sample that encodes the information.

### Embodiment 20

The system of embodiment 16 wherein the first information includes at least one of: a network address of the equipment; a identifier (ID) of the equipment; a name of the equipment; and a location or physical address of the equipment.

### Embodiment 21

The system of embodiment 16 wherein the mobile device is configured to use the first information to establish a digital communication connection between the mobile device and the identified merchant equipment by at least one of: establishing a wireless, optical, audio, or NFC connection between the mobile device and the equipment; establishing a connection between the mobile device and the equipment using an Internet or telecommunication networking protocol; and establishing a connection between the mobile device and the equipment using an infrared (IR) or visible light communication protocol.

### Embodiment 22

The system of embodiment 16 wherein the mobile device is configured to display the second information to the customer via the mobile device.

### Embodiment 23

The system of embodiment 16 wherein the second information is used to identify an item and the identified item or class of item is displayed to the customer via the mobile device.

### Embodiment 24

The system of embodiment 16 wherein the second information is used to determine whether a coupon associated with the item or class of item is available for use by the customer.

### Embodiment 25

The system of embodiment 24 wherein, upon determining that a coupon associated with the item or class of item is available, the mobile device is configured to at least one of: automatically apply the identified coupon to the item; determine that the customer does not have or have access to the coupon and, in response to that determination, offer to provide the coupon to the customer; provide the coupon to the customer for storage, immediate use, and/or later use; and prompt the customer to indicate whether or not to apply the identified coupon to the item.

### Embodiment 26

The system of embodiment 25 wherein the applied coupons are automatically redeemed by or on behalf of the merchant.

### Embodiment 27

The system of embodiment 25 wherein the identified coupon is stored on the mobile device.

### Embodiment 28

The system of embodiment 25 wherein the identified coupon was stored on a backend server and associated with the mobile device and/or the customer.

### Embodiment 29

The system of embodiment 16 wherein the mobile device displays a running and/or final total amount of the scanned or selected items to the customer.

### Embodiment 30

The system of embodiment 16 wherein the mobile device adds the scanned or selected items to an online cart or wishlist.

1-15. (canceled)

16. A system for communicating item information between a merchant equipment for scanning or selecting the item and a customer's mobile device, the system comprising:
a mobile device of a customer, the mobile device comprising:
a wireless transceiver;
one or more processors; and
memory storing instructions executable by the one or more processors, whereby the mobile device is operable to:
receive first information for identifying a merchant equipment for scanning or selecting an item;
use the first information to establish a digital communication connection between the mobile device and the identified merchant equipment; and
receive second information for identifying an item or class of item being scanned by the merchant equipment via the digital communication connection.

17. The system of claim 16 wherein the mobile device is operable to initiate purchase of the scanned or selected items using a payment application on the mobile device.

18. The system of claim 17 wherein the merchant equipment is at least one of:
a point of sale terminal;
a price checking kiosk; and
a display showing discounts, specials, or coupons.

19. The system of claim 16 wherein mobile device is configured to receive the first information by at least one of:
scanning and decoding a QR code or bar code that encodes the information;
receiving the information using a near field communication (NFC) protocol; and
receiving or recording and then decoding an audio sample that encodes the information.

20. The system of claim 16 wherein the first information includes at least one of:
a network address of the equipment;
a identifier (ID) of the equipment;
a name of the equipment; and
a location or physical address of the equipment.

21. The system of claim 16 wherein the mobile device is configured to use the first information to establish a digital communication connection between the mobile device and the identified merchant equipment by at least one of:
establishing a wireless, optical, audio, or NFC connection between the mobile device and the equipment;
establishing a connection between the mobile device and the equipment using an Internet or telecommunication networking protocol; and
establishing a connection between the mobile device and the equipment using an infrared (IR) or visible light communication protocol.

22. The system of claim 16 wherein the mobile device is configured to display the second information to the customer via the mobile device or to use the second information to identify an item or class of item and to display the identified item or class of item to the customer via the mobile device.

23. (canceled)

24. The system of claim 16 wherein the mobile device is further configured to use the second information to determine whether a coupon associated with the item or class of item is available for use by the customer, and, upon determining that a coupon associated with the item or class of item is available, perform at least one of:
notify the customer of the existence of the coupon;
automatically apply the identified coupon to the item;
determine that the customer does not have or have access to the coupon and, in response to that determination, offer to provide the coupon to the customer;
provide the coupon to the customer for storage, immediate use, and/or later use; and
prompt the customer to indicate whether or not to apply the identified coupon to the item.

25. (canceled)

26. The system of claim 24 wherein the applied coupons are automatically redeemed by or on behalf of the merchant.

27. The system of claim 24 wherein the identified coupon is stored on the mobile device and/or a backend server and associated with the mobile device and/or the customer.

28. (canceled)

29. The system of claim 16 wherein the mobile device displays a running and/or final total amount of the scanned or selected items to the customer.

30. The system of claim 16 wherein the mobile device adds the scanned or selected items to an online cart or wishlist.

31. A system for communicating item information between a merchant equipment for scanning or selecting the item and a customer's mobile device, the system comprising:
a mobile backend server, comprising:
a network interface;
one or more processors; and
memory storing instructions executable by the one or more processors, whereby the mobile backend server is operable to:
receive, from a mobile device, first information for identifying a merchant equipment for scanning or selecting an item;
use the first information to establish a digital communication connection between the mobile device and a merchant backend server associated with the merchant equipment;
receive, from the merchant backend server via the digital communication connection, second information for identifying an item or class of item being scanned or selected by the merchant equipment; and
send the second information to the mobile device.

32. The system of claim 31 wherein the first information includes at least one of:
a network address of the equipment;
a identifier (ID) of the equipment;
a name of the equipment; and
a location or physical address of the equipment.

33. The system of claim 31 wherein the first information includes information identifying a user of the mobile device, and wherein the mobile backend server is further operable to identify the user of the mobile device.

34. The system of claim 33 wherein the mobile backend server is further operable to determine whether there are any incentives available to the user.

35. The system of claim 34 wherein, upon determination that incentives are available to the user, the mobile backend server is further operable to at least one of:
automatically apply the incentive;
notify the user of the incentive; and
query the user to determine whether the user wants to apply the incentive or not.

36. The system of claim 33 wherein the mobile backend server is further operable to provide the identity of the user to the merchant backend server.

37. A method for communicating item information between a merchant equipment for scanning or selecting the item and a customer's mobile device, the method comprising:
at a mobile device of a customer:
receiving first information for identifying a merchant equipment for scanning or selecting an item, the merchant equipment comprising a point of sale terminal, a price checking kiosk, or a display showing discounts, specials, or coupons, and the first information comprising a network address of the equipment, an identifier of the equipment, a name of the equipment, a location of the equipment or a physical address of the equipment;
using the first information to establish a digital communication connection between the mobile device and the identified merchant equipment;
receiving, via the digital communication connection, second information for identifying an item or class of item being scanned by the merchant equipment;
displaying the second information to the customer via the mobile device or using the second information to identify an item or class of item and displaying the identified item or class of item to the customer via the mobile device;
using the second information to determine whether a coupon associated with the item or class of item is available for use by the customer, and, in response to determining that a coupon associated with the item or class of item is available and at least one of: notifying the customer of the existence of the identified coupon; automatically applying the identified coupon to the item; determining that the customer does not have or have access to the coupon and, in response to that determination, offering to provide the coupon to the customer; providing the coupon to the customer for storage, immediate use, and/or later use; and prompting the customer to indicate whether or not to apply the identified coupon to the item; and
displaying a running and/or final total amount of the scanned or selected items to the customer via the mobile device.

38. The method of claim 37 further comprising initiating purchase of the scanned or selected items using at least one of: a payment application on the mobile device; a credit, debit, or payment card; and cash.
